(19) United States
(12) Patent Application Publication
(10) Pub. No.: US 2017/0182844 A1
(43) Pub. Date: Jun. 29, 2017

(54) Pneumatic Tire, and Method of Manufacturing Pneumatic Tire

(71) Applicant: The Yokohama Rubber Co., LTD., Minato-ku, Tokyo (JP)

(72) Inventors: Hideki Seto, Hiratsuka-shi, Kanagawa (JP); Yoshiaki Hashimura, Hiratsuka-shi, Kanagawa (JP)

(21) Appl. No.: 15/301,934

(22) PCT Filed: Apr. 3, 2015
(86) PCT No.: PCT/JP2015/060599

§ 371 Date: Oct. 4, 2016

(30) Foreign Application Priority Data
Apr. 4, 2014 (JP) 2014-077772

(51) Int. Cl. B60C 5/14; B29D 30/06

(52) U.S. Cl. CPC B60C 5/14; B29D 30/0681; B60C 2005/147; B29D 2030/0682; B29K 2101/12

(57) ABSTRACT

In a pneumatic tire having a lap-splice portion in which an end section of a sheet laminate obtained by laminating an elastomer sheet and a thermoplastic resin composition sheet comprising a thermoplastic resin or a blended product of a thermoplastic resin and an elastomer is superimposed with another end of the sheet laminate and molded;
(a) a sheet laminate obtained by attaching the thermoplastic resin composition sheet and an elastomer sheet having a greater width in a tire circumferential direction than the thermoplastic resin composition sheet is used as the sheet laminate; and
(b) an excess width portion on at least one side of the elastomer sheet is folded back to a side of the thermoplastic resin composition sheet, and the folded back portion is superimposed with another end as an end section of the sheet laminate and molded.

### TECHNICAL FIELD

The present technology relates to a pneumatic tire and a method of manufacturing a pneumatic tire.

More particularly, the present technology relates to a pneumatic tire having a lap-splice portion in which an end section of a sheet laminate obtained by laminating an elastomer sheet and a thermoplastic resin composition sheet comprising a thermoplastic resin or a blended product of a thermoplastic resin and an elastomer is superimposed with the other end of the sheet laminate and molded, wherein after the pneumatic tire has begun traveling, cracks are not generated in the vicinity of the splice portion, enabling the tire to have excellent durability. The present technology also relates to a method of manufacturing a pneumatic tire having such characteristics.

### BACKGROUND ART

In recent years, the use of a sheet laminate obtained by laminating an elastomer sheet and a thermoplastic resin composition sheet comprising a thermoplastic resin or a blended product of a thermoplastic resin and an elastomer as a tire structural member of a pneumatic tire has been studied.

For example, the use of a sheet laminate obtained by laminating an elastomer sheet and a thermoplastic resin composition sheet comprising a thermoplastic resin or a blended product of a thermoplastic resin and an elastomer for an inner liner layer or a reinforcing member of an appropriate position of a pneumatic tire has been studied.

In order to use such a sheet laminate obtained by laminating an elastomer sheet and a thermoplastic resin composition sheet comprising a thermoplastic resin or a blended product of a thermoplastic resin and an elastomer as a tire structural member, a manufacturing method of winding the sheet laminate around a tire molding drum, lap-splicing the end sections, and using the resulting product in the tire vulcanization step is employed.

Specifically, when using a film forming a thermoplastic resin composition sheet comprising a thermoplastic resin or a blended product of a thermoplastic resin and an elastomer for an inner liner, a method of manufacturing a pneumatic tire having a lap-spliced inner liner layer by winding a laminate sheet, which is obtained by using a film serving as the thermoplastic resin composition sheet and a tie rubber sheet vulcanization-bonded to the film as an elastomer sheet and laminating the film and the tie rubber sheet, around a tire molding drum, lap-splicing the end sections, and using the resulting product in the tire vulcanization step is employed. Such a manufacturing method (when disposed over the entire periphery, the end sections are lap-spliced and disposed) is employed not only when used for an inner liner layer, but is also roughly the same when used as a reinforcing layer for appropriate positions of the tire.

However, there are cases in which, after the tire produced in this way began traveling, the thermoplastic resin composition sheet comprising a thermoplastic resin or a blended product of a thermoplastic resin and an elastomer is separated from the elastomer sheet vulcanization-bonded to the thermoplastic resin composition sheet. Alternatively, there are cases in which, when undergoing inflation at the time of vulcanization molding, the bonded state of the lap-spliced portion breaks down due to delamination or the like, causing the opening of the bonded portion formed by splicing.

In FIGS. 5A to 6, an example is illustrated in which a sheet laminate 1 comprising an elastomer sheet 3 and a film serving as a thermoplastic resin composition sheet 2 is used for an inner liner layer. As illustrated in FIG. 5A, the sheet laminate 1 comprising the elastomer sheet 3 and the thermoplastic resin composition sheet 2 comprising a thermoplastic resin or a blended product of a thermoplastic resin and an elastomer is formed to a size (length) determined in accordance with the tire size. A lap-splice portion S is disposed on both end sections on a tire molding drum (not illustrated) so as to form an annular shape, and the end sections are superimposed (overlapped) and lap-spliced. The elastomer sheet 3 forms a tire rubber layer. When one sheet laminate 1 is used, both end sections are lap-spliced and formed into an annular shape, or when a plurality of the sheet laminates 1 are used, the mutual end sections of each of the laminates are lap-spliced and bonded so as to be collectively formed as a single annular shape.

Next, other parts (not illustrated) required for tire manufacturing are wound and the tire undergoes vulcanization molding using a bladder. After the vulcanization molding, the thermoplastic resin composition sheet 2 comprising a thermoplastic resin or a blended product of a thermoplastic resin and an elastomer forms an inner liner layer 10, and in the vicinity of the lap-splice portion S, the portion where the thermoplastic resin composition sheet 2 is exposed to the cavity side and the portion where the thermoplastic resin composition sheet 2 is embedded in the elastomer sheet 3 (tie rubber layer) on the tire outer circumference side overlap via an elastomer sheet 3′ (tie rubber layer) so that the lap-splice portion S is formed, as illustrated in the model diagram of FIG. 5B. In FIGS. 5A and 5B, the upper part is the tire cavity side, the lower part is the tire outer circumference side, and the X-X direction is the tire circumferential direction.

That is, a pneumatic tire T having a splice portion S in which the end sections in the tire circumferential direction of the thermoplastic resin composition sheet 2 overlap via the elastomer sheet 3′ (tie rubber layer) over the tire width direction is formed, wherein the lap-splice portion S is present over the tire width direction E-E (FIG. 6).

The phenomenon in which the aforementioned thermoplastic resin composition sheet 2 and the elastomer sheet 3 (tie rubber layer) vulcanization-bonded to the thermoplastic resin composition sheet 2 are separated or the bonded part is opened after the tire has begun traveling or in the period from during vulcanization molding until immediately after molding occurs where the thermoplastic resin composition sheet 2 illustrated in FIG. 5B is exposed and in the vicinity of the tip portion 4 thereof, in particular, wherein a crack is first generated. This then develops into the separation of the thermoplastic resin composition sheet 2, the opening of the splice bonded part, or the like.

In order to prevent such cracking, the opening of the bonded part, or the like, the sheet laminate 1 has been studied variously with regard to the form in the vicinity of the end sections thereof (see Japanese Unexamined Patent Application Publication Nos. H10-129208A, H11-5261A and 2009-241855A).

As described above, the phenomenon in which the thermoplastic resin composition sheet 2 and the elastomer sheet 3 (tie rubber layer) vulcanization-bonded to the thermoplastic resin composition sheet 2 are separated or the bonded part is opened after the tire has begun traveling or in the period from during vulcanization molding until immediately after molding occurs where the thermoplastic resin composition sheet 2 illustrated in FIG. 5B is exposed and in the vicinity of the tip portion 4 thereof, in particular, wherein a crack is first generated. This then develops into the separation of the thermoplastic resin composition sheet 2, the opening of the bonded part, or the like.

However, although the conventional technology described above yields a constant effect with regard to the generation of cracks and the occurrence of separation, there remains a demand for improvement.

### SUMMARY

The present technology provides a pneumatic tire having a lap-splice portion in which an end section of a sheet laminate obtained by laminating an elastomer sheet and a thermoplastic resin composition sheet comprising a thermoplastic resin or a blended product of a thermoplastic resin and an elastomer is superimposed with the other end of the sheet laminate and molded, wherein a phenomenon such as the separation of the sheets or the opening of the bonded parts of the sheets does not occur after the pneumatic tire has begun traveling or in the period from during vulcanization molding until immediately after molding, enabling the tire to have excellent durability. The present technology also provides a manufacturing method thereof.

A pneumatic tire of the present technology that achieves the aforementioned object has the constitution (1) below.

(1) A pneumatic tire having a lap-splice portion in which an end section of a sheet laminate obtained by laminating an elastomer sheet and a thermoplastic resin composition sheet comprising a thermoplastic resin or a blended product of a thermoplastic resin and an elastomer being superimposed with another end of the sheet laminate and molded, wherein

(a) a sheet laminate obtained by attaching the thermoplastic resin composition sheet and an elastomer sheet having a greater width in a tire circumferential direction than the thermoplastic resin composition sheet being used as the sheet laminate; and

(b) an excess width portion on at least one side of the elastomer sheet being folded back to a side of the thermoplastic resin composition sheet, and the folded back portion being superimposed with another end as an end section of the sheet laminate and molded.

The pneumatic tire of the present technology described above preferably further has the constitution described in any one of (2) to (4) below.

(2) The pneumatic tire according to (1) above, wherein a thickness of the elastomer sheet is not less than 0.1 mm and not greater than 1 mm.

(3) The pneumatic tire according to (1) or (2) above, wherein a folded width of the elastomer sheet is not less than 3 mm and not greater than 80 mm.

(4) The pneumatic tire according to any one of (1) to (3) above, wherein a lap length L of the thermoplastic resin composition sheet in a superimposed portion of the sheet laminate is not less than 5 mm and not greater than 25 mm.

In addition, a manufacturing method for a pneumatic tire of the present technology that achieves the object described above has the following constitution (5).

(5) A manufacturing method for a pneumatic tire including a step of superimposing and molding an end section of a sheet laminate obtained by laminating an elastomer sheet and a thermoplastic resin composition sheet comprising a thermoplastic resin or a blended product of a thermoplastic resin and an elastomer with another end, the method comprising: attaching the thermoplastic resin composition sheet and an elastomer sheet having a greater width in a tire circumferential direction than the thermoplastic resin composition sheet to form a sheet laminate; and folding back an excess width portion on at least one side of the elastomer sheet to a side of the thermoplastic resin composition sheet, and superimposing the folded back portion with another end as an end section of the sheet laminate and using the resulting sheet laminate in a vulcanization molding step.

In addition, the manufacturing method for a pneumatic tire of the present technology preferably further has the constitution described in any one of (6) to (9) below.

(6) The manufacturing method for a pneumatic tire according to (5) above, wherein a thickness of the elastomer sheet is not less than 0.1 mm and not greater than 1 mm.

(7) The manufacturing method for a pneumatic tire according to (5) or (6) above, wherein a folded width of the elastomer sheet is not less than 3 mm and not greater than 80 mm.

(8) The manufacturing method for a pneumatic tire according to any one of (5) to (7) above, wherein a lap length L of the thermoplastic resin composition sheet in the superimposed portion of the sheet laminate is not less than 5 mm and not greater than 25 mm.

(9) The manufacturing method for a pneumatic tire according to any one of (5) to (8) above, wherein the excess width portion of the elastomer sheet is folded back to the side of the thermoplastic resin composition sheet under conditions where the elastomer sheet has a temperature of not lower than 40° C. and not higher than 120° C.

The pneumatic tire of the present technology described in (1) above provides a pneumatic tire having a lap-splice portion in which an end section of a sheet laminate obtained by laminating an elastomer sheet and a thermoplastic resin composition sheet comprising a thermoplastic resin or a blended product of a thermoplastic resin and an elastomer is superimposed with the other end of the sheet laminate and molded, wherein a phenomenon such as the separation of the sheets or the opening of the bonded parts of the sheets does not occur after the pneumatic tire has begun traveling or in the period from during vulcanization molding until immediately after molding, enabling the tire to have excellent durability.

In particular, the pneumatic tire of the present technology according to any one of (2) to (4) above provides a pneumatic tire that more prominently exhibits the effects of the present technology described in (1) above.

In addition, the manufacturing method for a pneumatic tire of the present technology described in (5) above can provide a method for manufacturing a pneumatic tire having a lap-splice portion in which an end section of a sheet laminate obtained by laminating an elastomer sheet and a thermoplastic resin composition sheet comprising a thermoplastic resin or a blended product of a thermoplastic resin and an elastomer is superimposed with the other end of the sheet laminate and molded, wherein a phenomenon in which the sheets are separated or the bonded parts of the sheets are opened does not occur after the pneumatic tire has begun traveling or in the period from during vulcanization molding until immediately after molding, enabling the tire to have excellent durability.

In particular, the manufacturing method for a pneumatic tire of the present technology according to any one of (6) to (8) above provides a manufacturing method for a pneumatic tire that more prominently exhibits the effects of the present technology described in (5) above.

### BRIEF DESCRIPTION OF DRAWINGS

FIGS. 1A and 1B are both diagrams for explaining an example of the structure of a splice portion of a pneumatic tire obtained by the present technology, and both drawings are for explaining a model of an example of a splice portion structure prior to vulcanization molding corresponding to FIG. 5A.

FIGS. 2A to 2D are model diagrams for explaining a first embodiment of the pneumatic tire of the present technology and the manufacturing method thereof.

FIGS. 3A to 3D are model diagrams for explaining another embodiment of the pneumatic tire of the present technology and a manufacturing method thereof.

FIG. 4 illustrates a model of an example of a technique when mechanically folding back an excess width portion of an elastomer sheet to a thermoplastic resin composition sheet side as an example of a manufacturing process when implementing the pneumatic tire of the present technology and the manufacturing method thereof.

FIGS. 5A and 5B are for explaining problems of the conventional art. FIG. 5A is a model diagram illustrating a state in which a sheet laminate having a prescribed size (length) and being formed from an elastomer sheet 3 and a thermoplastic resin composition sheet 2 comprising a thermoplastic resin or a blended product of a thermoplastic resin and an elastomer is provided with a splice portion S at both end sections thereof on a tire molding drum (not illustrated) and superimposed so as to form an annular shape. FIG. 5B is a model diagram illustrating a state after a tire is vulcanization-molded in the state illustrated in FIG. 5A.

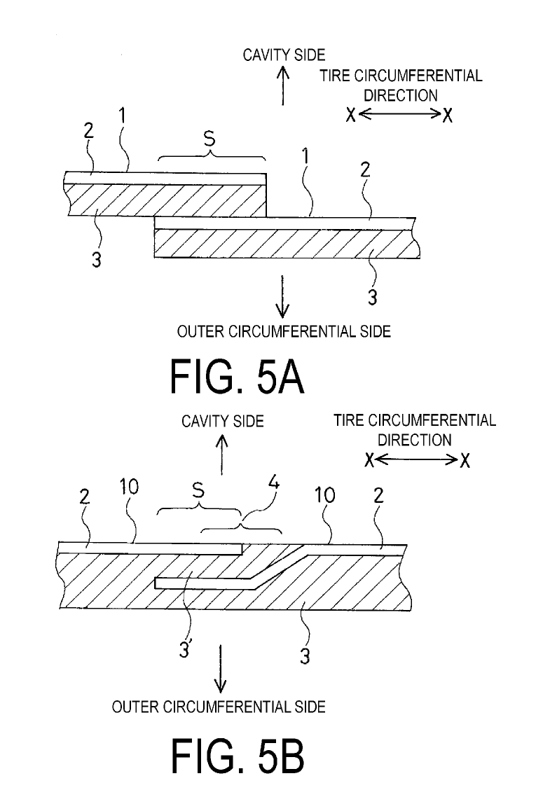

FIG. 6 is a partially fractured perspective view illustrating an example of a mode of the pneumatic tire according to the present technology, wherein the positional relationship of a lap-splice portion in the tire when the sheet laminate of the present technology comprising a thermoplastic resin composition sheet and an elastomer sheet is used in the formation of an inner liner layer is explained.

### DETAILED DESCRIPTION

A detailed explanation of the pneumatic tire of the present technology and the manufacturing method for the pneumatic tire will be given below.

The pneumatic tire of the present technology is a pneumatic tire having a lap-splice portion in which an end section of a sheet laminate obtained by laminating an elastomer sheet 3 and a thermoplastic resin composition sheet 2 comprising a thermoplastic resin or a blended product of a thermoplastic resin and an elastomer being superimposed with another end of the sheet laminate and molded, wherein

(a) a sheet laminate 1 obtained by attaching the thermoplastic resin composition sheet 2 and an elastomer sheet 3 having a greater width in a tire circumferential direction than the thermoplastic resin composition sheet 2 being used as the sheet laminate 1; and

(b) an excess width portion on at least one side of the elastomer sheet 3 being folded back to a side of the thermoplastic resin composition sheet 2, and the folded back portion being superimposed with another end as an end section of the sheet laminate 1 and molded.

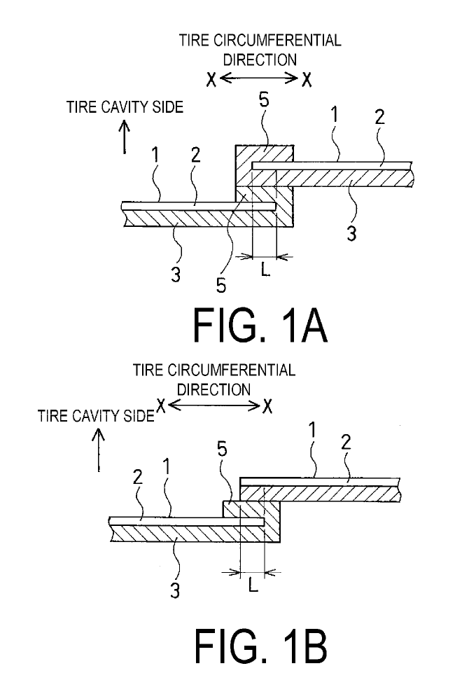

FIG. 1 is a side view illustrating the lap-splice portion realized in the pneumatic tire of the present technology, wherein when a sheet laminate obtained by attaching a thermoplastic resin composition sheet 2 and an elastomer sheet 3 having a greater width in the tire circumferential direction than the thermoplastic resin composition sheet 2 is used as the sheet laminate 1, the excess width portion on at least one side of the elastomer sheet 3 is folded back to the thermoplastic resin composition sheet 2, and the folded back portion 5 is superimposed with another end as an end section of the sheet laminate 1 and molded (vulcanization molding).

When vulcanization molding is performed by lap-splicing in this manner, the spliced bonding surface is between the elastomer sheets 3, so vulcanization molding/vulcanization bonding is performed with the same materials, as illustrated in FIGS. 1A and 1B. As a result, the bonding strength (splice strength) can be made greater than in the case of a bond with another material. In addition, both tip portions (in the case of FIG. 1A) or one tip portion (in the case of FIG. 1B) of the thermoplastic resin composition sheet 2 is completely embedded in the elastomer sheets 3. The strength of the bond between the elastomer sheets 3 and the embedded structure together minimize the occurrence of cracks or fissures in the vicinity of the splice portion, which makes it possible to dramatically suppress the occurrence of problems such as the opening of the bonded part.

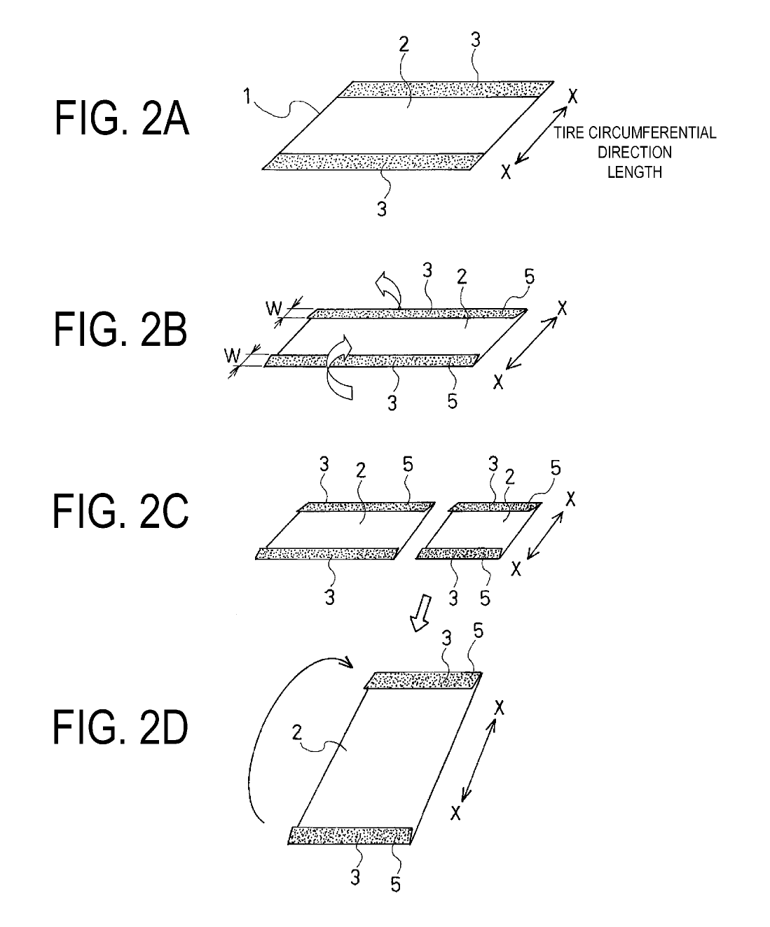

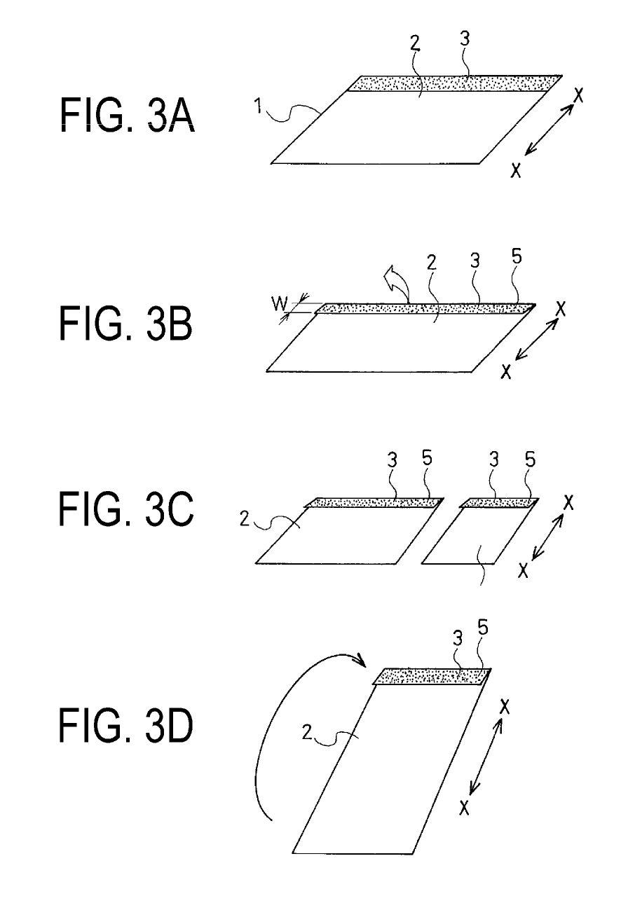

FIG. 1A illustrates a case in which the folded back portions 5 are disposed on both end sections of the sheet laminate 1, and FIG. 1B illustrates a case in which the folded back portion 5 is disposed on only one end section. An example of the procedure for forming the folded back portions in each case is illustrated for a case in which the folded back portions 5 are disposed on both end sections in FIGS. 2A to 2D and for a case in which the folded back portion 5 is disposed on one end section in FIGS. 3A to 3D.

First, as illustrated in FIGS. 2A and 3A, the sheet laminate 1 is obtained by attaching the thermoplastic resin composition sheet 2 and the elastomer sheet 3 having a greater width in the tire circumferential direction than the thermoplastic resin composition sheet 2, and the excess width portion on at least one side of the elastomer sheet 3 is folded back to the thermoplastic resin composition sheet 2 (arrows in FIGS. 2B and 3B) so as to form the folded back portion 5 (FIGS. 2B and 3B). Further, the sheet is cut as illustrated in FIGS. 2C and 3C in accordance with the width of the tire to be manufactured and is bent (arrow direction) so as to form an annular shape and so that the thermoplastic resin composition sheet 2 side is the center side of the annular shape (tire cavity side), as illustrated in FIGS. 2D and 3D, and the end sections of the sheet laminate 2 are lap-spliced. In this way, a spliced structure such as that illustrated in FIGS. 1A and 1B can be realized, and the effects described above can be achieved.

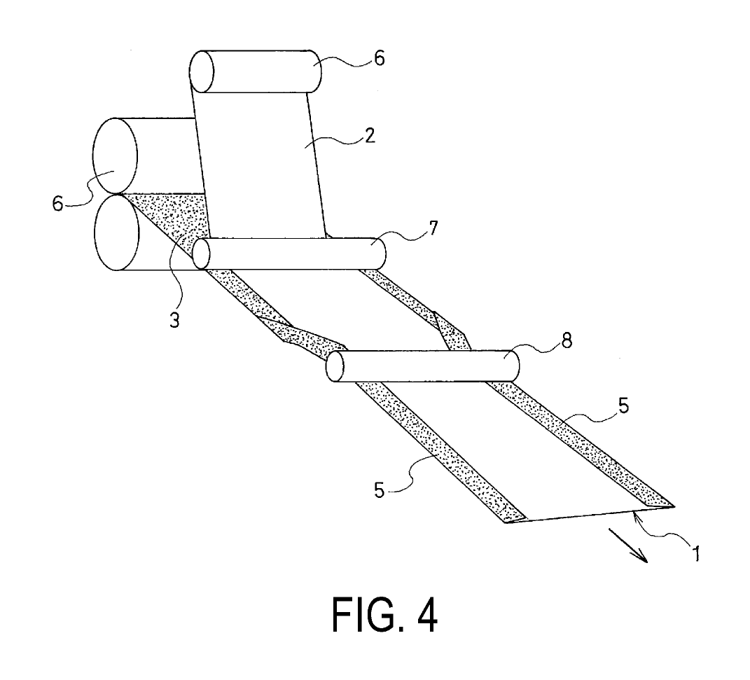

FIG. 4 illustrates a model of an example of a technique when mechanically folding back the excess width portion of the elastomer sheet 3 to the thermoplastic resin composition sheet 2 side during the rolling process of the elastomer sheet 3 as an example of the manufacturing process when implementing the pneumatic tire of the present technology and the manufacturing method thereof. Reference numeral 6 denotes a feeding roller, 7 denotes a laminate pressing roller, and 8 denotes a folded back portion pressing roller.

The thickness T of the elastomer sheet 3 is not particularly limited but is preferably not less than 0.1 mm and not greater than 1 mm from a practical standpoint. When the thickness becomes too large such a degree to exceed 1 mm, it becomes difficult to fold the sheet back, and it becomes difficult to fold the sheet with good precision and efficiency. When the thickness is less than 0.1 mm, wrinkles tend to form, and process management becomes difficult, which is not preferable. The thickness of the elastomer sheet is more preferably not less than 0.5 mm and not greater than 0.7 mm.

The folded width W of the elastomer sheet 3 (FIGS. 2A to 3D) is preferably not less than 3 mm and not greater than 80 mm. When the folded width is short such as less than 3 mm, the effect of the present technology becomes poor and the splice portion tends to open easily, whereas when the folded is long such a degree to exceed 80 mm, wrinkles tend to form at the time of folding, which is not preferable. However, depending on the tire dimensions or the like, the form of the folded back portion may assume a structure in which folding is performed to a length so that the entire thermoplastic resin composition sheet 2 is completely or almost completely covered.

In addition, in the superimposed portion, the lap length L of the thermoplastic resin composition sheet 2 (FIGS. 1A and 1B) is preferably not less than 5 mm and not greater than 25 mm. When the lap length L is short such as less than 5 mm, the opening of the splice tends to occur easily, which is not preferable, whereas when the lap length L is greater than 25 mm, the uniformity tends to be diminished, which is not preferable. The lap length L of the thermoplastic resin composition sheet is more preferably not less than 5 mm and not greater than 15 mm.

The method for manufacturing the pneumatic tire of the present technology described above is a manufacturing method for a pneumatic tire including a step of superimposing and molding an end section of a sheet laminate 1 obtained by laminating an elastomer sheet 3 and a thermoplastic resin composition sheet 2 comprising a thermoplastic resin or a blended product of a thermoplastic resin and an elastomer with another end, the method comprising: attaching the thermoplastic resin composition sheet 2 and an elastomer sheet 3 having a greater width in a tire circumferential direction than the thermoplastic resin composition sheet to form the sheet laminate 1; and folding back an excess width portion on at least one side of the elastomer sheet 3 to a side of the thermoplastic resin composition sheet 2, and superimposing the folded back portion with another end as an end section of the sheet laminate 1 and using the resulting sheet laminate 1 in a vulcanization molding step.

When executing this method, the preferred thickness T of the elastomer sheet 3, the preferred folded width W of the elastomer sheet 3, the preferred lap length of the thermoplastic resin composition sheet 2, and the like are the same as described above.

Although not particularly limited, a sheet having a thickness from 30 to 300 μm is preferably used as the thermoplastic resin composition sheet 2 used in the present technology.

In addition, the excess width portion of the elastomer sheet 3 is preferably folded back to the thermoplastic resin composition sheet side under conditions where the elastomer sheet has a temperature of not lower than 40° C. and not higher than 120° C. In particular, by folding the elastomer sheet 3 at a temperature of not lower than 40° C., the adhesion between the thermoplastic resin composition sheet 2 and the elastomer sheet 3 is enhanced, which further suppresses delamination during the vulcanization molding step or the like. When the sheet is folded at a high temperature exceeding 120° C., the vulcanization of the elastomer sheet may progress prior to tire vulcanization molding, which is not preferable from the perspective of adhesion and requires caution. According to the findings of the present inventors, folding is more preferably performed at an elastomer sheet 3 temperature of not lower than 60° C. and not higher than 90° C.

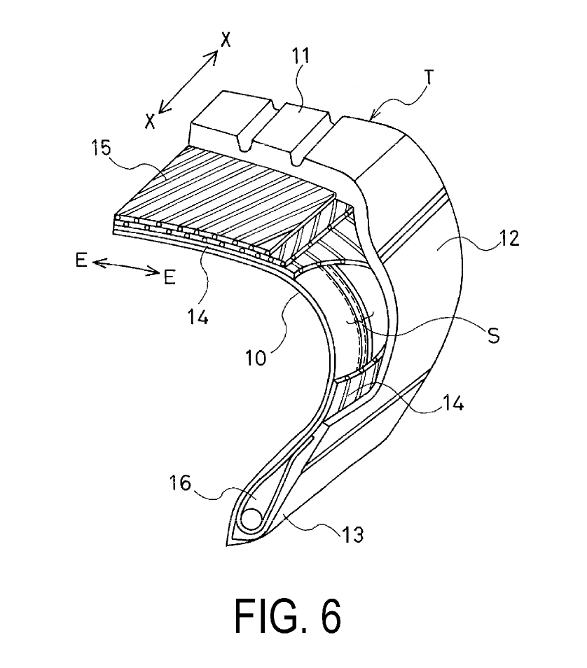

FIG. 6 is a partially fragmented perspective view illustrating an example of an aspect of the pneumatic tire according to the present technology.

A pneumatic tire T is provided with a tread portion 11, sidewall portions 12, and bead portions 13, the sidewall portions 12 and the bead portions 13 being connected on the left and right of the tread portion 11. On the tire inner side thereof, a carcass layer 14 that acts as a framework for the tire is provided so as to extend between the left and right bead portions 13, 13 in the tire width direction. Two belt layers 15 composed of steel cords are disposed on the outer circumferential side of the carcass layer 4 corresponding to the tread portion 11. The arrow E indicates the tire width direction, and the arrow X indicates the tire circumferential direction. An inner liner layer 10 is disposed on an inner side of the carcass layer 14, and a splice portion S thereof is present extending in the tire width direction.

In the pneumatic tire according to the present technology, the generation of cracks, the occurrence of separation, and the occurrence of the opening of the bond portion that conventionally tend to occur in the vicinity of the splice portion S on the tire inner circumferential surface are suppressed, and durability is noticeably improved.

Two sheets, which are typically a film-like sheet comprising a “thermoplastic resin” and a sheet of a film comprising a “blended product prepared by maintaining a thermoplastic resin as the main component while blending an elastomer into the resin” are collectively referred to as the “thermoplastic resin composition sheet” in the present technology. Even in the case of the latter, the main component is a thermoplastic resin, and a film containing a thermoplastic resin as the main component typically has the property that the rigidity is greater than that of a sheet made of rubber 100% or the like. Therefore, as the constitution of the present technology described above, protecting the vicinity of the splice portion of the sheet is important from the perspective of lengthening the life of the pneumatic tire.

The thermoplastic resins and elastomers that can be used in the thermoplastic resin composition sheet 2 of the present technology will be described hereinafter.

Preferable examples of thermoplastic resins that can be used in the thermoplastic resin composition sheet 2 of the present technology include a polyamide resin (e.g., nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 copolymer (N6/66/610), nylon MXD6 (MXD6), nylon 6T, nylon 9T, nylon 6/6T copolymer, nylon 66/PP copolymer, nylon 66/PPS copolymer) or an N-alkoxyalkyl compound thereof, e.g., a methoxymethyl compound of nylon 6, a methoxymethyl compound of a nylon 6/610 copolymer, or a methoxymethyl compound of nylon 612; a polyester resin (e.g., an aromatic polyester such as polybutylene terephthalate (PBT), polyethylene terephthalate (PET), polyethylene isophthalate (PEI), a PET/PEI copolymer, polyarylate (PAR), polybutylene naphthalate (PBN), a liquid crystal polyester, a polyoxyalkylene diimide acid/polybutylene terephthalate copolymer); a polynitrile resin (e.g., polyacrylonitrile (PAN), polymethacrylonitrile, an acrylonitrile/styrene copolymer (AS), a (meta)acrylonitrile/styrene copolymer, a (meta)acrylonitrile/styrene/butadiene copolymer), a polymethacrylate resin (e.g., polymethyl-methacrylate (PMMA), polyethyl-methacrylic acid), a polyvinyl resin (e.g., polyvinyl acetate, a polyvinyl alcohol (PVA), a vinyl alcohol/ethylene copolymer (EVOH), polyvinylidene chloride (PVDC), polyvinylchloride (PVC), a vinyl chloride/vinylidene chloride copolymer, a vinylidene chloride/methylacrylate copolymer, a vinylidene chloride/acrylonitrile copolymer (ETFE)), a cellulose resin (e.g., cellulose acetate, cellulose acetate butyrate), a fluoride resin (e.g., polyvinylidene difluoride (PVDF), polyvinyl fluoride (PVF), polychlorofluoroethylene (PCTFE), a tetrafluoroethylene/ethylene copolymer), and an imide resin (e.g., an aromatic polyimide (PI)).

Furthermore, of the thermoplastic resin and the elastomer constituting the blended product that can be used in the thermoplastic resin composition sheet 2 of the present technology, the same resins as those described above may be used as the thermoplastic resin. Preferable examples of the elastomer constituting the blended product preferably include a diene-based rubber or a hydrogenate thereof (e.g., natural rubber (NR), isoprene rubber (IR), epoxidized natural rubber, styrene butadiene rubber (SBR), butadiene rubber (BR, high cis-BR, and low cis-BR), nitrile rubber (NBR), hydrogenated NBR, hydrogenated SBR), an olefin rubber (e.g., ethylene propylene rubber (EPDM, EPM), maleic acid modified ethylene propylene rubber (M-EPM), butyl rubber (IIR), an isobutylene and aromatic vinyl or diene-based monomer copolymer, acrylic rubber (ACM), an ionomer), a halogen-containing rubber (e.g., Br-IIR, CI-IIR, a brominated isobutylene-p-methylstyrene copolymer (BIMS), chloroprene rubber (CR), a hydrin rubber (CHR), chlorosulfonated polyethylene rubber (CSM), chlorinated polyethylene rubber (CM), chlorinated polyethylene rubber modified with maleic acid (M-CM)), a silicon rubber (e.g., methyl vinyl silicon rubber, dimethyl silicon rubber, methylphenyl vinyl silicon rubber), a sulfur-containing rubber (e.g., polysulfide rubber), a fluororubber (e.g., a vinylidene fluoride rubber, a vinyl ether rubber containing fluoride, a tetrafluoroethylene-propylene rubber, a silicon-based rubber containing fluoride, a phosphazene rubber containing fluoride), and a thermoplastic elastomer (e.g., a styrene elastomer, an olefin elastomer, an ester elastomer, a urethane elastomer, a polyamide elastomer).

In particular, it is preferable for at least 50 wt. % of the elastomer to be a halogenated butyl rubber, a brominated isobutylene-paramethyl-styrene copolymer rubber, or a maleic anhydride-modified ethylene a olefin copolymer rubber from the perspective of being able to increase the rubber volume ratio so as to soften and enhance the durability of the elastomer at both low and high temperatures.

In addition, it is preferable for at least 50 wt. % of the thermoplastic resin in the blended product to be any one of nylon 11, nylon 12, nylon 6, nylon6, nylon 66, a nylon 6/66 copolymer, a nylon 6/12 copolymer, a nylon 6/10 copolymer, a nylon 4/6 copolymer, a nylon 6/66/12 copolymer, aromatic nylon, or an ethylene/vinyl alcohol copolymer from the perspective of being able to achieve both durability and air permeation preventive properties.

Moreover, when the compatibility is different upon obtaining a blended product by blending a combination of the previously specified thermoplastic resin and the previously specified elastomer, a suitable compatibility agent may be used as a third component to enable compatibilization of both the resin and the elastomer. By mixing the compatibility agent in the blend, interfacial tension between the thermoplastic resin and the elastomer is reduced, and as a result, the particle diameter of the elastomer that forms the dispersion phase becomes very small and thus the characteristics of both components may be realized effectively. In general, such a compatibility agent has a copolymer structure of both or either the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. While the type of compatibility agent may be selected according to the type of thermoplastic resin and elastomer to be blended, such a compatibility agent generally includes: a styrene/ethylene butylene block copolymer (SEBS) or a maleic acid modified compound thereof; a EPDM, EPM, EPDM/styrene or EPDM/acrylonitrile graft copolymer or a maleic acid modified compound thereof; a styrene/maleic acid copolymer, or a reactive phenoxy, and the like. The blending quantity of such a compatibility agent, while not being limited, is preferably 0.5 to 10 parts by weight with respect to 100 parts by weight of the polymer component (total of the thermoplastic resin and the elastomer).

A composition ratio of the specified thermoplastic resin and the elastomer in the blended product obtained by blending a thermoplastic resin with an elastomer is not particularly limited and may be determined as appropriate to establish a dispersed structure as a discontinuous phase of the elastomer in the matrix of the thermoplastic resin, and is preferably in a range of a weight ratio of 90/10 to 30/70.

In the present technology, a compatibilizing agent or other polymer may be blended with the thermoplastic resin or the blended product obtained by blending a thermoplastic resin and an elastomer within a range that does not diminish the characteristics required for an inner liner or within a range that does not diminish the characteristics required for a reinforcing member. The purposes of mixing such a polymer are to improve the compatibility between the thermoplastic resin and the elastomer, to improve the molding workability of the material, to improve the heat resistance, to reduce cost, and the like. Examples of the material used for the polymer include polyethylene (PE), polypropylene (PP), polystyrene (PS), ABS, SBS, polycarbonate (PC), and the like.

Furthermore, a reinforcing agent such as a filler (calcium carbonate, titanium oxide, alumina, and the like), carbon black, or white carbon, a softening agent, a plasticizer, a processing aid, a pigment, a dye, an anti-aging agent, or the like that are generally blended with polymer compounds may be optionally blended so long as the characteristics required for an inner liner or reinforcing agent are not impaired. The blended product of a thermoplastic resin and an elastomer has a structure in which the elastomer is distributed as a discontinuous phase in the matrix of the thermoplastic resin. By having such a structure, it becomes possible to provide the inner liner or the reinforcing material with sufficient flexibility and sufficient air permeation preventive properties attributed to the effect of the resin layer as a continuous phase. Furthermore, it becomes possible to obtain, during molding, a molding workability equivalent to that of the thermoplastic resin regardless of the amount of the elastomer.

Furthermore, the elastomer blended with the thermoplastic resin can be dynamically vulcanized when being mixed with the thermoplastic resin. A vulcanizer, a vulcanization aid, vulcanization conditions (temperature, time), and the like, during the dynamic vulcanization can be determined as appropriate in accordance with the composition of the elastomer to be added, and are not particularly limited.

When the elastomer in the thermoplastic resin composition is dynamically vulcanized in this manner, the obtained resin film sheet becomes a sheet that contains a vulcanized elastomer. Therefore, the sheet has resistance (elasticity) against deformation from the outside, which is preferable in that the effect of the present technology can be enhanced.

Generally available rubber vulcanizers (crosslinking agents) can be used as the vulcanization agent. Specifically, as a sulfur-based vulcanizer, powdered sulfur, precipitated sulfur, highly dispersible sulfur, surface treated sulfur, insoluble sulfur, dimorpholine disulfide, alkylphenol disulfide, and the like can be illustrated, and, for example, approximately 0.5 to 4 phr (in the present specification, “phr” refers to parts by weight per 100 parts by weight of an elastomer component; same hereinafter) can be used.

Moreover, examples of an organic peroxide-based vulcanizer include benzoyl peroxide, t-butyl hydroperoxide, 2,4-dichlorobenzoyl peroxide, 2,5-dimethyl-2,5-di(t-butyl peroxy)hexane, 2,5-dimethylhexane-2,5-di(peroxyl benzoate), and the like. Such an organic peroxide-based vulcanizer can be used in an amount of, for example, around 1 to 20 phr.

Furthermore, examples of a phenol resin-based vulcanizer include brominated alkylphenol resins and mixed crosslinking system containing an alkyl phenol resin with a halogen donor such as tin chloride and chloroprene. Such a phenol resin-based vulcanizer can be used in an amount of, for example, around 1 to 20 phr.

Examples of other vulcanizers include zinc oxide (approximately 5 phr), magnesium oxide (approximately 4 phr), litharge (approximately 10 to 20 phr), p-quinone dioxime, p-dibenzoylquinone dioxime, tetrachloro-p-benzoquinone, poly-p-dinitrosobenzene (approximately 2 to 10 phr), and methylenedianiline (approximately 0.2 to 10 phr).

As necessary, a vulcanization accelerator may be added. As the vulcanization accelerator, approximately 0.5 to 2 phr, for example, of a generally available vulcanization accelerator of an aldehyde-ammonia base, a guanidine base, a thiazole base, a sulfenamide base, a thiuram base, a dithio acid salt base, a thiourea base, or the like can be used.

Specific examples include an aldehyde ammonia vulcanization accelerator such as hexamethylene tetramine and the like; a guanidine vulcanization accelerator such as diphenyl guanidine and the like; a thiazole vulcanization accelerator such as dibenzothiazyl disulfide (DM), 2-mercaptobenzothiazole and its Zn salt, a cyclohexylamine salt, and the like; a sulfenamide vulcanization accelerator such as cyclohexyl benzothiazyl sulfenamide (CBS), N-oxydiethylene benzothiazyl-2-sulfenamide, N-t-butyl-2-benzothiazole sulfenamide, 2-(thymol polynyl dithio)benzothiazole, and the like; a thiuram vulcanization accelerator such as tetramethylthiuram disulfide (TMTD), tetraethylthiuram disulfide, tetramethylthiuram monosulfide (TMTM), dipentamethylenethiuram tetrasulfide, and the like; a dithionate vulcanization accelerator such as Zn-dimethyl dithiocarbamate, Zn-diethyl dithiocarbamate, Zn-di-n-butyl dithiocarbamate, Zn-ethylphenyl dithiocarbamate, Te-diethyl dithiocarbamate, Cu-dimethyl dithiocarbamate, Fe-dimethyl dithiocarbamate, pipecoline pipecolyl dithiocarbamate, and the like; and a thiourea vulcanization accelerator such as ethylene thiourea, diethyl thiourea, and the like. Additionally, a vulcanization accelerator which is generally-used for a rubber can be used. For example, zinc oxide (approximately 5 phr), stearic acid, oleic acid and their Zn salts (approximately 2 to 4 phr), or the like can be used.

The elastomer sheet 3 used in the present technology is preferably an elastomer sheet containing any one type or plurality of types of natural rubber, isoprene rubber, styrene-butadiene rubber, butadiene rubber, and butyl rubber conventionally used as a tie rubber as the main component in the polymer. Further, the elastomer sheet 3 preferably comprises an adhesive rubber from the perspective of the manufacturing process. In this case, even if the elastomer sheet 3 and the thermoplastic resin composition sheet 2 comprising a thermoplastic resin or a blended product of a thermoplastic resin and an elastomer are laminated directly without using an adhesive layer, the product can be basically treated as an integrated product, which is preferable.

In addition, as described above, the excess width portion of the elastomer sheet 3 is preferably folded back to the thermoplastic resin composition sheet side under conditions where the elastomer sheet 3 has a temperature of not lower than 40° C. and not higher than 120° C. In particular, by folding the elastomer sheet 3 at a temperature of not lower than 40° C., the adhesion between the thermoplastic resin composition sheet 2 and the elastomer sheet 3 improves, so delamination is unlikely to occur even during the vulcanization molding step or the like, which is preferable.

### EXAMPLES

The present technology will be specifically described below using working examples and the like.

### Working Examples 1 to 12 and Comparative Example 1

Five test tires of a tire size 195/65R15 91H (15×6J) having a tire structure comprising two belt layers and one carcass layer were produced for each of Working Examples 1 to 12 and Comparative Example 1.

Each test tire was evaluated by performing vulcanization molding commonly using sheets with the compositions shown in Table 1 as the thermoplastic resin composition sheet 2 (thickness: 130 μm) to form an inner liner, and sheets with the compositions shown in Table 2 as the elastomer sheet 3 (thickness: 0.7 mm) serving as a tie rubber, and assessing whether molding can be completed without the splice portion being separated in the vulcanization molding step. In each case, the lap length L of the thermoplastic resin composition sheet was 10 mm.

TABLE 1

| | | Parts |
|---|---|---|
| | | by |
| | | mass |
| BIMS^{a)} | “Exxpro 3035” made by ExxonMobile Chemical | 100 |
| | Co. | |
| Zinc oxide | “Zinc white type III” made by Seido Chemical | 0.5 |
| | Industry Co., Ltd. | |
| Stearic acid | Industrial stearic acid | 0.2 |
| Zinc stearate | “Zinc stearate” made by NOF Corporation | 1 |
| N6/66 | “UBE Nylon 5033B” made by Ube Industries, Ltd. | 100 |
| Modified | “HPR-AR201” made by Dupont-Mitsui | 10 |
| EEA^{b)} | Polychemicals Co., Ltd. | |

Remarks:
^{a)}A brominated isobutylene-p-methylstyrene copolymer
^{b)}Maleic anhydride-modified ethylene-ethylacrylate copolymer

TABLE 2

| | | Parts |
|---|---|---|
| | | by |
| | | mass |
| Styrene butadiene | Made by Zeon Corporation | 50 |
| rubber | “Nipol 1502” | |
| Natural rubber | SIR-20 | 50 |
| Carbon black | Made by Tokai Carbon Co., Ltd | 60 |
| | “Seast V” | |
| Stearic acid | Industrial stearic acid | 1 |
| Aroma oil | Made by Showa Shell Sekiyu KK | 7 |
| | “Aroma oil: Desolex No. 3” | |
| Zinc oxide | Made by Seido Chemical Industry Co., Ltd. | 3 |
| | “Zinc oxide III” | |
| Modified resorcin | Made by Taoka Chemical Co., Ltd. | 2 |
| formaldehyde | “Sumikanol 620” | |
| condensate | | |
| Methylene donor | Modified ether methylolmelamine | 6 |
| | made by Taoka Chemical Co., Ltd. | |
| | “Sumikanol 507 AP” | |
| Sulfur | 5% oil-extension treated sulfur | 6 |
| Vulcanization | Di-2-benzothiazolyl disulfide | 2.2 |
| accelerator | made by Ouchi Shinko Chemical Industrial | |
| | Co., Ltd. | |
| | “NOCCELER DM” | |

As shown in Tables 3 and 4, each tire was evaluated visually under the following evaluation criteria while changing the presence or absence of folding, whether folding was performed on one side or both sides, the folded width, the temperature of the elastomer sheet at the time of folding, the thickness of the elastomer sheet, and the like.

The evaluation test results are as shown in Tables 3 and 4.

TABLE 3

| | | Working | Working | Working | Working | Working | Working |
|---|---|---|---|---|---|---|---|
| | Comparative | Example | Example | Example | Example | Example | Example |
| | Example 1 | 1 | 2 | 3 | 4 | 5 | 6 |
| Presence/ | Absence | One side | One side | One side | One side | One side | One side |
| absence of | | | | | | | |
| folding | | | | | | | |
| Tie rubber | 0.7 | 1.0 | 0.1 | 1.0 | 0.1 | 1.0 | 1.0 |
| (elastomer | | | | | | | |
| sheet) | | | | | | | |
| thickness | | | | | | | |
| (mm) | | | | | | | |
| Folded | No | 20 | 20 | 3 | 3 | 20 | 20 |
| width (mm) | | | | | | | |
| Temperature | — | 25 | 25 | 25 | 25 | 40 | 120 |
| of elastomer | | | | | | | |
| at the time | | | | | | | |
| of folding | | | | | | | |
| (° C.) | | | | | | | |
| Evaluation | Fail | Good | Excellent | Good | Good | Excellent | Excellent |
| based on | | | | | | | |
| presence/ | | | | | | | |
| absence of | | | | | | | |
| splice | | | | | | | |
| opening | | | | | | | |

TABLE 4

| | Working | Working | Working | Working | Working | Working |
|---|---|---|---|---|---|---|
| | Example | Example | Example | Example | Example | Example |
| | 7 | 8 | 9 | 10 | 11 | 12 |
| Presence/absence of | Both | Both | Both | Both | Both | Both |
| folding | sides | sides | sides | sides | sides | sides |
| Tie rubber (elastomer | 0.5 | 0.1 | 0.5 | 0.1 | 0.5 | 0.5 |
| sheet) thickness (mm) | | | | | | |
| Folded width (mm) | 20 | 20 | 3 | 3 | 20 | 20 |
| Temperature of | 25 | 25 | 25 | 25 | 40 | 120 |
| elastomer at the time | | | | | | |
| of folding (° C.) | | | | | | |
| Evaluation based on | Good | Excellent | Good | Excellent | Excellent | Excellent |
| presence/absence of | | | | | | |
| splice opening | | | | | | |

(1) Evaluation of splice portion opening resistance:

The five test tires produced in each of Working Examples 1 to 12 and Comparative Example 1 were evaluated in three stages in accordance with the following evaluation criteria.

(a) Excellent: No delamination was observed in the splice portion of three tires

(b) Good: Delamination with dimensions of at most 1 mm×1 mm was observed in even one tire (no delamination observed in other tires)

(c) Poor: Delamination with dimensions greater than 1 mm×1 mm was observed in even one tire (no delamination observed in other tires)

1. A pneumatic tire comprising:
a lap-splice portion in which an end section of a sheet laminate obtained by laminating an elastomer sheet and a thermoplastic resin composition sheet comprising a thermoplastic resin or a blended product of a thermoplastic resin and an elastomer being superimposed with another end of the sheet laminate and molded, wherein
(a) a sheet laminate obtained by attaching the thermoplastic resin composition sheet and an elastomer sheet having a greater width in a tire circumferential direction than the thermoplastic resin composition sheet being used as the sheet laminate; and
(b) an excess width portion on at least one side of the elastomer sheet being folded back to a side of the thermoplastic resin composition sheet, and the folded back portion being superimposed with another end as an end section of the sheet laminate and molded.

2. The pneumatic tire according to claim 1, wherein a thickness T of the elastomer sheet is not less than 0.1 mm and not greater than 1 mm.

3. The pneumatic tire according to claim 1, wherein a folded width W of the elastomer sheet is not less than 3 mm and not greater than 80 mm.

4. The pneumatic tire according to claim 1, wherein a lap length L of the thermoplastic resin composition sheet in a superimposed portion of the sheet laminate is not less than 5 mm and not greater than 25 mm.

5. A manufacturing method for a pneumatic tire including a step of superimposing and molding an end section of a sheet laminate obtained by laminating an elastomer sheet and a thermoplastic resin composition sheet comprising a thermoplastic resin or a blended product of a thermoplastic resin and an elastomer with another end, the method comprising:
attaching the thermoplastic resin composition sheet and an elastomer sheet having a greater width in a tire circumferential direction than the thermoplastic resin composition sheet to form a sheet laminate; and
folding back an excess width portion on at least one side of the elastomer sheet to a side of the thermoplastic resin composition sheet, and superimposing the folded back portion with another end as an end section of the sheet laminate and using the resulting sheet laminate in a vulcanization molding step.

6. The manufacturing method for a pneumatic tire according to claim 5, wherein a thickness T of the elastomer sheet is not less than 0.1 mm and not greater than 1 mm.

7. The manufacturing method for a pneumatic tire according to claim 5, wherein a folded width W of the elastomer sheet is not less than 3 mm and not greater than 80 mm.

8. The manufacturing method for a pneumatic tire according to claim 5, wherein a lap length L of the thermoplastic resin composition sheet in a superimposed portion of the sheet laminate is not less than 5 mm and not greater than 25 mm.

9. The manufacturing method for a pneumatic tire according to claim 5, wherein the excess width portion of the elastomer sheet is folded back to the side of the thermoplastic resin composition sheet under conditions where the elastomer sheet has a temperature of not lower than 40° C. and not higher than 120° C.

10. The pneumatic tire according to claim 2, wherein a folded width W of the elastomer sheet is not less than 3 mm and not greater than 80 mm.

11. The pneumatic tire according to claim 10, wherein a lap length L of the thermoplastic resin composition sheet in a superimposed portion of the sheet laminate is not less than 5 mm and not greater than 25 mm.

12. The manufacturing method for a pneumatic tire according to claim 6, wherein a folded width W of the elastomer sheet is not less than 3 mm and not greater than 80 mm.

13. The manufacturing method for a pneumatic tire according to claim 12, wherein a lap length L of the thermoplastic resin composition sheet in a superimposed portion of the sheet laminate is not less than 5 mm and not greater than 25 mm.

14. The manufacturing method for a pneumatic tire according to claim 13, wherein the excess width portion of the elastomer sheet is folded back to the side of the thermoplastic resin composition sheet under conditions where the elastomer sheet has a temperature of not lower than 40° C. and not higher than 120° C.
